(19) United States
(12) Patent Application Publication
(10) Pub. No.: US 2024/0171556 A1
(43) Pub. Date: May 23, 2024

(54) Network Time Protocol Key Encryption

(71) Applicant: Tlefonaktiebolaget LM Ericsson (publ), Stockholm (SE)

(72) Inventors: Daiying Liu, Beijing (CN); Renwang Liu, Beijing (CN); Zhaoyu Ai, Beijing (CN)

(21) Appl. No.: 18/552,505

(22) PCT Filed: Mar. 30, 2021
(86) PCT No.: PCT/CN2021/084005

§ 371 Date: Sep. 26, 2023

(51) Int. Cl. H04L 9/40

(52) U.S. Cl. CPC H04L 63/0442

(57) ABSTRACT

Methods and devices for encrypting network time protocol keys in communication networks are disclosed. A method comprises obtaining an original NTP key, obtaining a local encryption key for encrypting the original NTP key, encrypting the original NTP key using the obtained local encryption key and saving the encrypted NTP key.

### TECHNICAL FIELD

The present disclosure generally relates to communication networks, and more particularly relates to methods and devices for network time protocol key encryption in communication networks.

### BACKGROUND

Network Time Protocol (NTP) is widely used to synchronize computer clocks on the Internet. RFC (Request for Comments) 5905 of the IETF (Internet Engineering Task Force) defines version 4 of the Network Time Protocol (NTPv4), which is backwards compatible with NTP version 3 (NTPv3), described in RFC1305, as well as with previous versions of the protocol. NTPv4 is widely used to synchronize system clocks among a set of distributed time servers and clients.

NTP security requirements are more stringent than most other distributed services because the operation of the authentication mechanism and the time synchronization mechanism are inextricably intertwined, and reliable time synchronization requires cryptographic keys that are valid only over a designated time interval.

The NTP protocol does not encrypt the whole NTP packet, it just appends a cryptographic signature with the NTP trust key to the NTP packet. The cryptographic signature allows the NTP client to be sure that the NTP packet it receives really originates from the NTP server it is expected from and has not been spoofed. However, the NTP keys storage method is currently deficient. NTP client and server store NTP keys as decrypted content in their local file systems. The method is not safe because anyone who can access the local file system can get the NTP keys and may use the NTP keys to disrupt the whole clock network system.

### SUMMARY

Some embodiments herein may advantageously solve or at least mitigate one or more of the problems discussed above.

More particularly, some embodiments include a method performed by a device using network time protocol (NTP). The method comprises obtaining an original NTP key, obtaining a local encryption key for encrypting the original NTP key and encrypting the original NTP key using the obtained local encryption key. The method may further comprises saving the encrypted NTP key.

In some embodiments, encrypting the original NTP key may further comprise encrypting the original NTP key using a hardware module. In some embodiments, the hardware module may comprise a Hardware Security Module (HSM) or a Trusted Platform Module (TPM).

In some embodiments, the obtained local encryption key may comprise a private key of a hardware module.

In some other embodiments, encrypting the original NTP key may further comprise encrypting the original NTP key using a software. In some embodiments, obtaining a local encryption key for encrypting the original NTP key may further comprise generating the local encryption key by the software.

According to another aspect, some embodiments include a method performed by a device using network time protocol (NTP). The method may comprise obtaining an NTP key and determining whether the NTP key is an encrypted NTP key.

In some embodiments, the method may further comprise, responsive to the NTP key being an encrypted NTP key, decrypting the encrypted NTP key.

In some embodiments, the method may further comprise, responsive to the NTP key being an encrypted NTP key, determining whether the encrypted NTP key is encrypted with a latest version of an encryption algorithm if the encryption algorithm has been updated.

In some embodiments, the method may further comprise, responsive to the encrypted NTP key being not encrypted with a latest version of an encryption algorithm, decrypting the encrypted NTP key with a current encryption algorithm to obtain an original NTP key, encrypting the original NTP key with the latest version of the encryption algorithm, and saving the encrypted NTP key.

In some embodiments, the method may further comprise, responsive to the NTP key not being an encrypted NTP key, obtaining a local encryption key for encrypting the original NTP key, encrypting the original NTP key using the obtained local encryption key, and saving the encrypted NTP key.

According to another aspect, some embodiments include a device configured to use network time protocol (NTP). The device may comprise processing circuitry and memory. The memory contains instructions that, when executed by the processing circuitry, cause the device to obtain an original NTP key, obtain a local encryption key for encrypting the original NTP key, and encrypt the original NTP key using the obtained local encryption key. The memory may further include instructions that, when executed by the processing circuitry, cause the device to save the encrypted NTP key.

In some embodiments, the memory may further include instructions that, when executed by the processing circuitry, cause the device to encrypt the original NTP key using a hardware module in the encryption step. In some embodiments, the hardware module may comprise a Hardware Security Module (HSM) or a Trusted Platform Module (TPM).

In some embodiments, the memory may further include instructions that, when executed by the processing circuitry, cause the device to encrypt the original NTP key using a software in the encryption step.

According to another aspect, some embodiments include a device configured to use network time protocol (NTP). The device may comprise processing circuitry and memory. The memory contains instructions that, when executed by the processing circuitry, cause the device to obtain an NTP key and determine whether the NTP key is an encrypted NTP key.

In some embodiments, the memory may further include instructions that, when executed by the processing circuitry, cause the device to, responsive to the NTP key being an encrypted NTP key, decrypt the encrypted NTP key.

In some embodiments, the memory may further include instructions that, when executed by the processing circuitry, cause the device to, responsive to the NTP key being an encrypted NTP key, determine whether the encrypted NTP key is encrypted with a latest version of an encryption algorithm if the encryption algorithm has been updated.

In some embodiments, the memory may further include instructions that, when executed by the processing circuitry, cause the device to, responsive to the encrypted NTP key being not encrypted with a latest version of an encryption algorithm, decrypt the encrypted NTP key with a current encryption algorithm to obtain an original NTP key, encrypt the original NTP key with the latest version of the encryption algorithm, and save the encrypted NTP key.

In some embodiments, the memory may further include instructions that, when executed by the processing circuitry, cause the device to, responsive to the NTP key not being an encrypted NTP key, obtain a local encryption key for encrypting the original NTP key, encrypt the original NTP key using the obtained local encryption key, and save the encrypted NTP key.

According to another aspect, some embodiments include a computer program product. The computer program product comprises computer-readable instructions stored in a non-transitory computer-readable storage medium of the computer program product. When the instructions are executed by processing circuitry (e.g., at least one processor) of a device, they enable the device to perform one or more of the described device functionalities.

According to another aspect, some embodiments also include corresponding computer programs and carriers. A computer program comprises instructions which, when executed on processing circuitry of a device configured to use NTP, cause the device to carry out any of the embodiments described above. Embodiments further include a carrier containing such a computer program. This carrier may comprise one of an electronic signal, optical signal, radio signal, or computer readable storage medium.

### BRIEF DESCRIPTION OF THE DRAWINGS

Exemplary embodiments will be described in more detail referring to the following figures, in which:

FIG. 1 is a NTP Packet Header Format.

FIG. 2 is a schematic diagram illustrating an example of NTP key access architecture according to the prior art.

FIG. 3 is a schematic diagram illustrating an example of NTP key access architecture according to some embodiments.

FIG. 4 is a flow chart of operations for encrypting an NTP key according to some embodiments.

FIG. 5 is a flow chart of operations for decrypting an NTP key according to some embodiments.

FIG. 6 is a flow chart of operations for detecting the status of an NTP key according to some embodiments.

FIG. 7 is a flow chart of operations for updating encryption algorithm according to some embodiments.

FIG. 8 is a logic flow diagram of a method performed by a device according to some embodiments.

FIG. 9 is another logic flow diagram of a method performed by a device according to some embodiments.

FIG. 10 is a block diagram of a device according to some embodiments.

FIG. 11 is another block diagram of a device according to some embodiments.

### DETAILED DESCRIPTION

The embodiments set forth below represent information to enable those skilled in the art to practice the embodiments. Upon reading the following description, given the accompanying figures, those skilled in the art will understand the concepts of the description and will recognize applications of these concepts not addressed herein. These concepts and applications fall within the scope of the description.

In the following description, numerous specific details are set forth. However, it is understood that embodiments may be practiced without these specific details. In other instances, well-known circuits, structures, and techniques have not been shown in order not to obscure the understanding of the description. Those of ordinary skill in the art, with the included description, can implement appropriate functionality without undue experimentation.

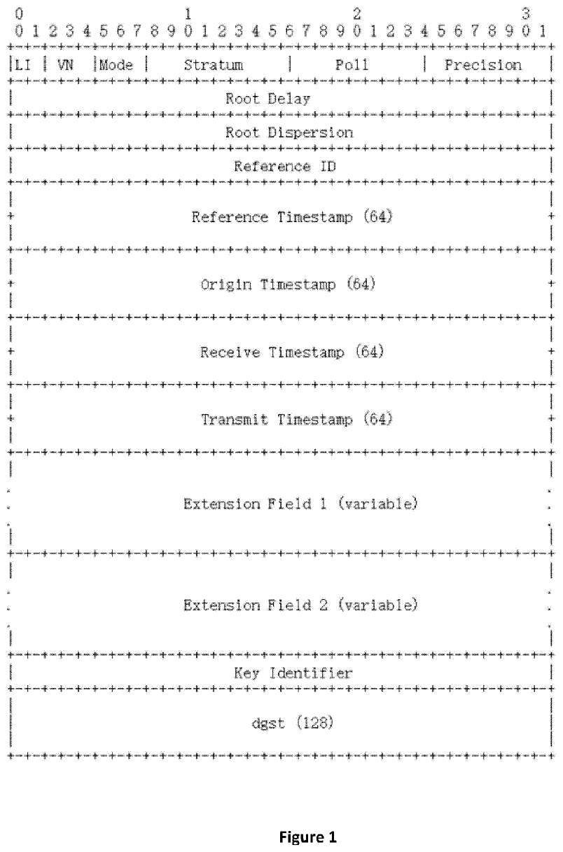

Referring to FIG. 1, a NTP Packet Header Format as defined in RFC 5905 is illustrated. RFCs 1305 and 5905 also define an authentication method for NTP protocol exchanging for security as below:

The NTP packet is a UDP datagram [RFC0768]. Some fields use multiple words and others are packed in smaller fields within a word. In FIG. 1, the size of some multiple-word fields is shown in bits if not the default 32 bits. The NTP packet header shown in FIG. 1 has 12 words followed by optional extension fields (i.e., Extension Field 1 and Extension Field 2) and an optional message authentication code (MAC) consisting of the Key Identifier field and the Message Digest field.

The Key Identifier (keyid) field comprises a 32-bit unsigned integer used by the NTP client and NTP server to designate a secret 128-bit MD5 key (the MD5 message-digest algorithm is a widely used hash function producing a 128-bit hash value). The key content is saved on a NTP device (e.g., NTP client or NTP server) locally but is not carried in the exchanged protocol messages.

The Message Digest (digest) field comprises a 128-bit MD5 hash computed over the key followed by the NTP packet header and extensions fields (but not the Key Identifier or Message Digest fields).

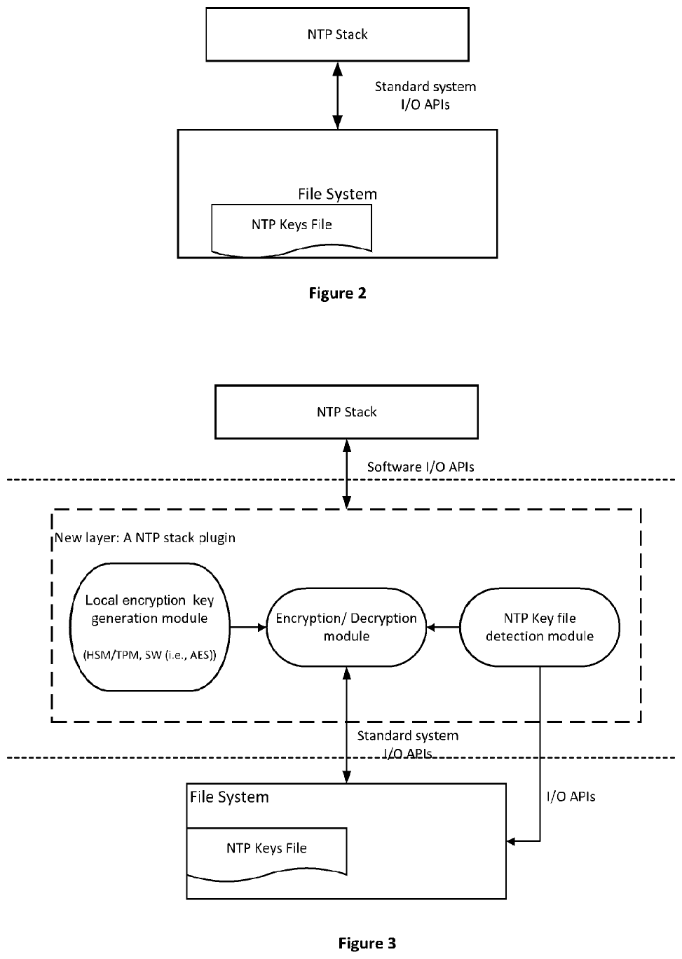

FIG. 2 is a schematic diagram illustrating an example of a conventional NTP key access architecture. As illustrated, the NTP keys are saved locally in the file system of a device as an NTP keys file. The NTP keys can be stored and read by the NTP stack via input/output application programming interfaces (I/O APIs) of the file system.

FIG. 3 is a schematic diagram illustrating an example of an NTP key access architecture according to some embodiments. As illustrated, compared to the conventional architecture illustrated in FIG. 2, in the architecture of FIG. 3, a new abstraction layer, referred to as an NTP stack plugin, is added between the NTP stack and the file system on the device. The plugin provides software I/O APIs between the NTP stack and itself and provides standard system I/O APIs between itself and the file system.

The plugin also provides some common interfaces including but not limited to below for NTP process:

Get the original NTP key (referring to the key_string as below) for NTP stack to do the negotiation:
get_ntp_auth_key(char *key_string);

Save an NTP key, and use the “cipher_type” parameter to identify the encryption algorithm before saving to the filesystem:
save_ntp_key(int cipher_type, char *key_string);

The NTP stack plugin comprises a local encryption key generation module, an encryption/decryption module and an NTP key file detection module. The local encryption key generation module may comprise a hardware module, e.g., a Hardware Security Module (HSM) or a Trusted Platform Module (TPM) for generating a local encryption key (e.g., a private key of the hardware module). The local encryption key generation module may also comprise a software for generating a local encryption key (e.g., a private key).

TPM, also known as ISO/IEC 11889, is an international standard for a secure crypto processor, a dedicated microcontroller designed to secure hardware through integrated cryptographic keys. In general, TPM can be used to indicate a hardware integrating secure crypto processor.

HSM is a physical computing device that contains one or more secure crypto processor chips. It safeguards and manages digital keys, performs encryption and decryption functions for digital signatures, strong authentication, and other cryptographic functions.

A device will comprise a hardware module (e.g., an HSM or a TPM) when there would be a significant, negative impact to the owner of the key if it were compromised. For example, many laptops contain TPM chips and many enterprise servers comprise HSM cards.

The hardware module (e.g., HSM/TPM) could be detected by specific application programming interface (API) provided by the operating system. For example, once the device is booted up or rebooted, the hardware will be detected. If there is a such hardware module, the hardware encryption will be used, otherwise, the software encryption will be used.

When there is no such hardware module, the local encryption key is generated based, at least in part, on at least one identifier of the device, e.g., a Subscriber Permanent Identity (SUPI), Subscriber Concealed Identity (SUCI) which is an encrypted SUPI, a Mobile Station International Subscriber Directory Number (MSISDN), an International Mobile Subscriber Identity (IMSI), a Media Access Control (MAC) address, a serial number of the device, or an external ID of the device, etc.

The MAC address is a unique identifier assigned to a network interface controller (NIC) for use as a network address in communications within a network segment. The serial number is a unique identifier assigned to a device in a product portfolio. These 2 unique identifiers can be combined into a globally unique string as the local encryption key. For example, the device MAC address is 00:01:00:0a:0a:04 and the device serial number is D823066971, then the combination of these two unique identifiers 00:01:00:0a:0a:04-D823066971 can be used as a private key.

When the NTP stack stores an NTP key to the file system, the plugin will encrypt the original key string using a local encryption key generated by the local encryption key generation module and write it to the NTP keys file on the file system via the standard system I/O APIs.

When the NTP stack reads an encrypted NTP key from the file system, the plugin will retrieve the encrypted NTP key from the file system, decrypt the key string using the local encryption key generated by the local encryption key generation module, and send the decrypted NTP key to the NTP stack via a software API between the NTP stack and the plugin.

For the encryption/decryption process, the plugin can also automatically detect, every time when it starts the process, if there is a hardware module, e.g., an HSM or a TPM for generating a local encryption key (e.g., a private key of the hardware module) on the device.

The plugin can also detect the status of the NTP key, e.g., whether the NTP key is an encrypted key or not, and, if encrypted, whether the NTP key is encrypted with the latest version of the encryption algorithm if the encryption algorithm has been updated.

Such plugin can be used to improve the capability of real deployment for an NTP device. For example, using such plugin could avoid a server which already runs NTP service to change its configuration, i.e., the NTP keys file on the file system.

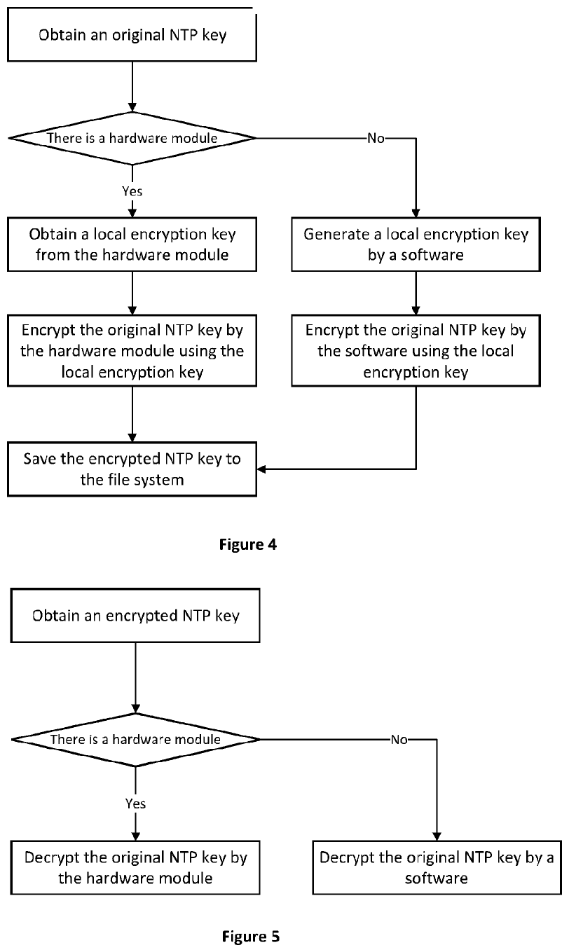

FIG. 4 is a flow chart of operations for encrypting an NTP key according to some embodiments. When a device obtains an original NTP key, it will encrypt it before storing it. The device will detect whether there is a hardware module, e.g., an HSM or a TPM, for generating a local encryption key (e.g., a private key of the hardware module) on the device.

If there is a such hardware module, the device will obtain a local encryption key from the hardware module, and then encrypt the original NTP key using the local encryption key. In some embodiments, the local encryption key is a private key of the hardware module. In some embodiments, it is the hardware module itself that encrypts the original NTP key using the local encryption key. In some embodiments, the hardware module is an HSM or a TPM.

If there is no such hardware module, the device will obtain or otherwise generate a local encryption key using a software, and then encrypt the original NTP key using the local encryption key. In some embodiments, the local encryption key is generated based, at least in part, on at least one identifier of the device. The identifier of the device may be a Subscriber Permanent Identity (SUPI), Subscriber Concealed Identity (SUCI) which is an encrypted SUPI, a Mobile Station International Subscriber Directory Number (MSISDN), an International Mobile Subscriber Identity (IMSI), a Media Access Control (MAC) address, a serial number of the device, an external identifier of the device, etc.

All standard public encryption schemes can be used to encrypt the NTP keys. For example, Data Encryption Standard (DES), Advanced Encryption Standard (AES), MD5 Message-Digest Algorithm, Secure Hash Algorithm (SHA) family, Rivest-Shamir-Adleman (RSA), Blowfish and Twofish, etc. All private encryption schemes also can be used to encrypt the original NTP keys.

After encrypting the original NTP key, the device will save the encrypted NTP key to the file system of the device. When saving the encrypted NTP key, an indication may be added to indicate that the NTP key is an encrypted NTP key. Further, another indication may be added to indicate the encryption algorithm used for encrypting the NTP key.

In some embodiments, as mentioned in FIG. 3, when saving an NTP key, the parameter “cipher_type” is used to identify the encryption algorithm:
save_ntp_key(int cipher_type, char *key_string);

When saving encrypted NTP keys, a specific string, e.g., “#Cryped Keys AES128”, may be added to identify the encryption algorithm in the NTP keys file. According to the identifier, it's explicit whether the NTP keys are encrypted or not, and which encryption algorithm is used.

Thus, when the encryption algorithm is updated, this parameter value of “cipher_type” and the specific string identifying the encryption algorithm need to be updated. According to the parameter “cipher_type”, the specific encryption algorithm will be selected and used. Moreover, if the latest version of encryption algorithm doesn't exist yet in the device, the encryption software library or encryption hardware module needs to be updated too.

The device may not need to detect whether there is such hardware module on the device every time when it needs to encrypt an original NTP key. Instead, this detection can be done every time when the device is booted up or rebooted and the device will know it then.

FIG. 5 is a flow chart of operations for decrypting an NTP key according to some embodiments. When a device needs to use a NTP key, it first obtains an encrypted NTP key. The device will then detect whether there is a hardware module, e.g., an HSM or a TPM, for generating a local encryption key (e.g., a private key of the hardware module) on the device.

If there is such hardware module, the device will decrypt the encrypted NTP key using the hardware module. In some embodiments, the hardware module decrypts the encrypted NTP key by using a local encryption key obtained from the hardware module, e.g., a private key of the hardware module. In some embodiments, the hardware module is an HSM or a TPM.

If there is no such hardware module, the device will decrypt the encrypted NTP key by a software. In some embodiments, the device decrypts the encrypted NTP key by using a local encryption key generated by the software. In some embodiments, the local encryption key is generated based, at least in part, on at least one identifier of the device. The identifier of the device may be a Subscriber Permanent Identity (SUPI), a Subscriber Concealed Identity (SUCI) which is an encrypted SUPI, a Mobile Station International Subscriber Directory Number (MSISDN), an International Mobile Subscriber Identity (IMSI), a Media Access Control (MAC) address, a serial number of the device, an external identifier of the device, etc.

The device may not need to detect whether there is such a hardware module on the device every time when it needs to decrypt an encrypted NTP key. Instead, this detection can be done every time when the device is booted up or rebooted and the device will know it then.

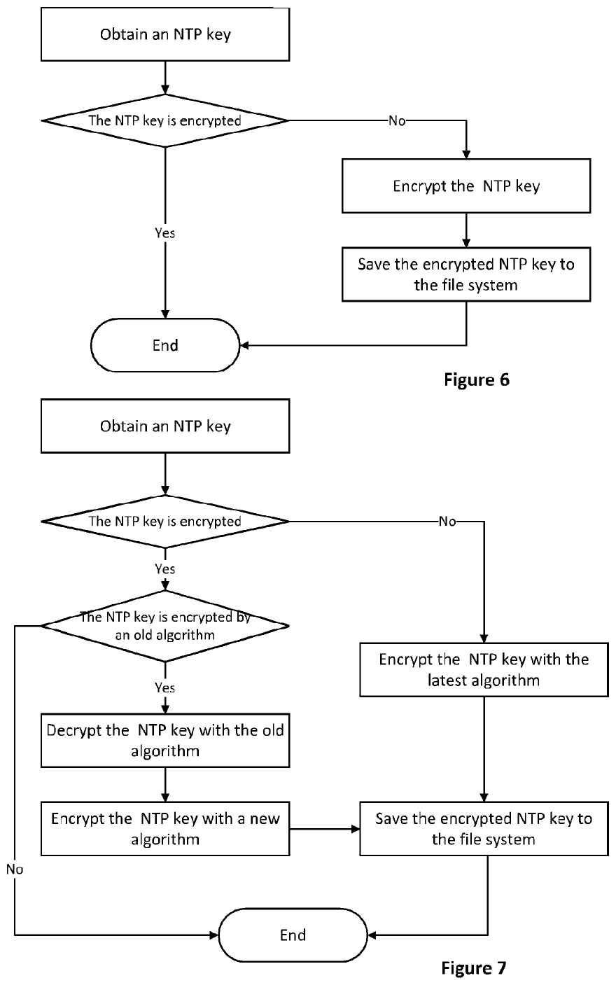

FIG. 6 is a flow chart of operations for detecting the status of an NTP key according to some embodiments. When a device installs the plugin disclosed above, it may already have some NTP keys which have been stored without encryption. To protect the NTP keys, the plugin will detect which ones of the NTP keys stored in the file system are encrypted and which ones are not. When the plugin detects that an NTP key is not encrypted, it will encrypt it using, for instance, the process shown in FIG. 4, and then store it back in the file system.

FIG. 7 is a flow chart of operations for updating the encryption algorithm according to some embodiments. Updating the encryption algorithm means changing the encryption algorithm used to encrypt an NTP key from a first algorithm (e.g., algorithm A) to a second algorithm (e.g., algorithm B).

As mentioned above with respect to in FIG. 3, when saving an NTP key, the parameter “cipher_type” is used to identify the encryption algorithm:
save_ntp_key(int cipher_type, char *key_string);

When the encryption algorithm is updated, a new encryption algorithm (e.g., algorithm B) will replace an old encryption algorithm (e.g., algorithm A). To make sure the NTP keys which are encrypted by the old encryption algorithm can still be decrypted, when the encryption algorithm is updated, the device will check the NTP keys saved in the file system. As illustrated in the flow diagram in FIG. 7, if an NTP key is not encrypted, the device will encrypt the NTP key with the new encryption algorithm. If the NTP key has been encrypted by an old encryption algorithm, the device will first decrypt it using the old encryption algorithm, for instance using the process shown in FIG. 5, and then encrypt it with the new encryption algorithm. After that, it will save the NTP key encrypted with the new encryption algorithm to the file system and update the parameter “cipher_type” in the save string (save_ntp_key(int cipher_type, char *key_string)) to identify the new encryption algorithm.

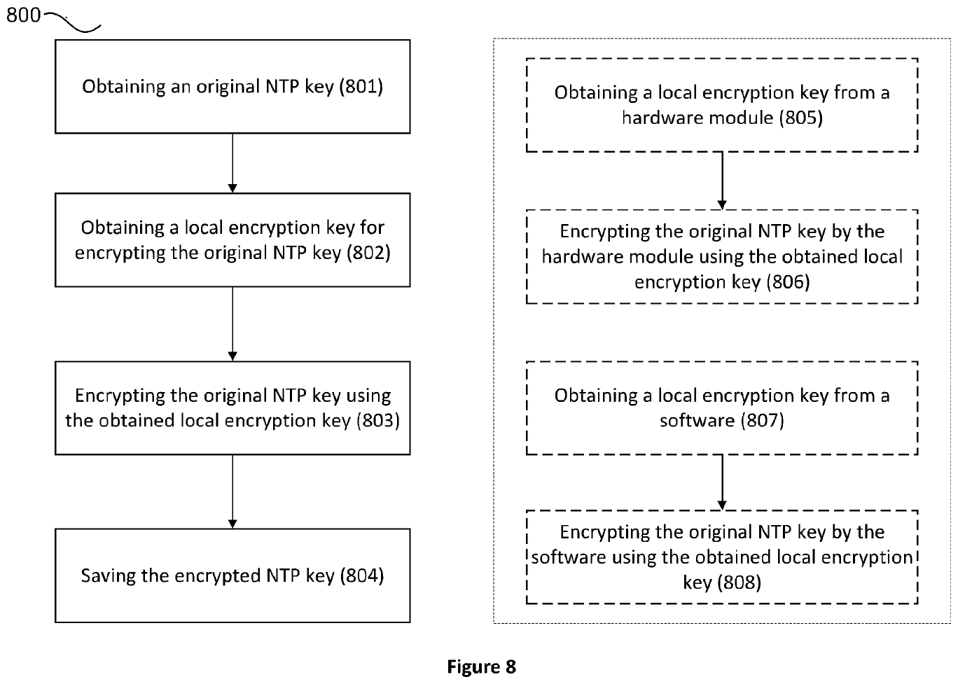

FIG. 8 is a logic flow diagram of a method 800 performed by a device according to some embodiments. Blocks in dashed lines are optional. The method 800 in some embodiments may comprise obtaining an original NTP key (Block 801), obtaining a local encryption key for encrypting the original NTP key (Block 802), and encrypting the original NTP key using the obtained local encryption key (Block 803) to obtain an encrypted NTP key. In some embodiments, the method 100 may further comprise saving the encrypted NTP key (Block 804).

In some embodiments, obtaining the local encryption key may comprise obtaining the local encryption key from a hardware module (e.g., a HSM or TPM) for generating a local encryption key (such as a private key) on the device (Block 805). Further, encrypting the original NTP key may comprise encrypting the original NTP key by the hardware module by using the obtained local encryption key (Block 806).

In some embodiments, obtaining the local encryption key may comprise obtaining the local encryption key from a software (Block 807). Further, encrypting the original NTP key may comprise encrypting the original NTP key by the software by using the obtained local encryption key (Block 808).

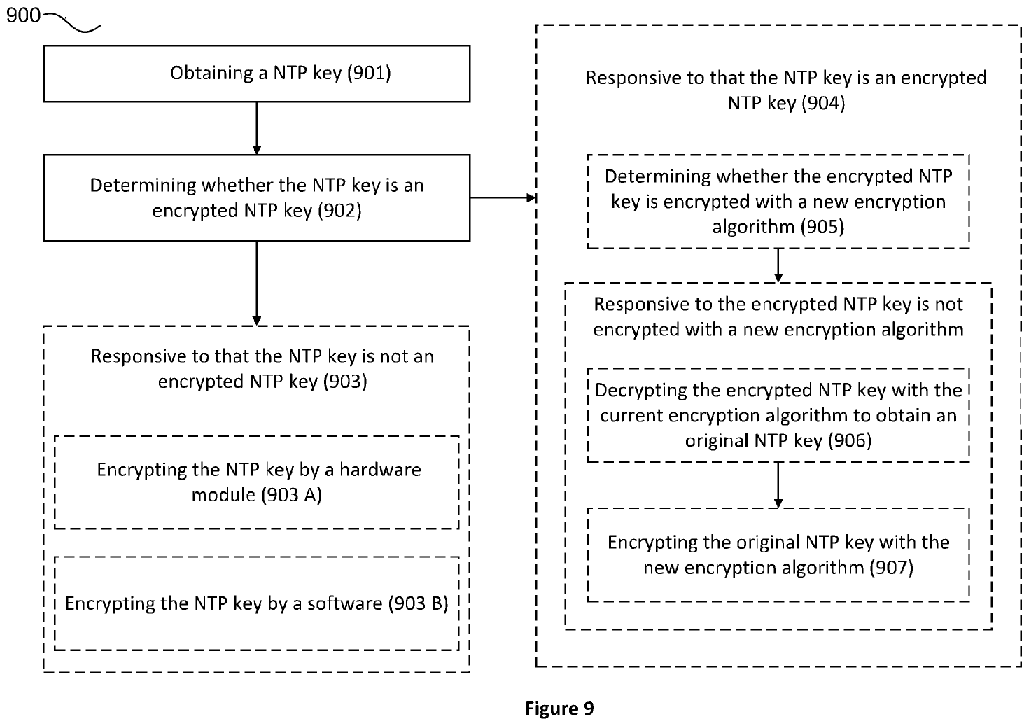

FIG. 9 is another a logic flow diagram of a method 900 performed by a device according to some embodiments. Blocks in dashed lines are optional. The method 900 in some embodiments may comprise obtaining an NTP key (Block 901) and determining whether the NTP key is an encrypted NTP key (Block 902).

In some embodiments, responsive to that the NTP key is not an encrypted NTP key (Block 903), the method 900 may further comprise encrypting the NTP key by a hardware module (903 A). In some embodiments, responsive to that the NTP key is not an encrypted NTP key (Block 903), the method 900 may further comprises encrypting the NTP key by a software (903 B).

In some embodiments, responsive to that the NTP key is an encrypted NTP key (Block 904), the method 900 may further comprise determining whether the encrypted NTP key is encrypted with a latest version of an encryption algorithm if the encryption algorithm has been updated (Block 905). In some embodiments, responsive to that the encrypted NTP key is not encrypted with the latest version of the encryption algorithm, the method 900 may further comprise decrypting the encrypted NTP key with the current encryption algorithm to obtain an original NTP key (Block 906), and then encrypting the original NTP key with the latest version of the encryption algorithm (Block 907). Decrypting the NTP key may further comprise decrypting the NTP key by a hardware module or by a software (not shown in the figure), which is shown in FIGS. 4 and 5.

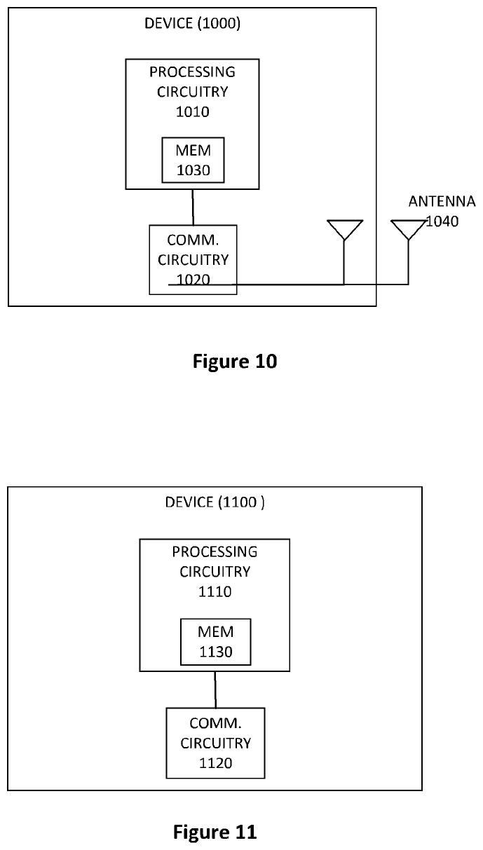

FIG. 10 is a block diagram of an example of a wireless device 1000 according to some embodiments. Wireless device 1000 includes processing circuitry 1010 and communication circuitry 1020. As shown, the communication circuitry 1020 (e.g., radio circuitry) is configured to transmit and/or receive information to and/or from one or more other nodes, e.g., via any communication technology. Such communication may occur via one or more antennas 1040 that are either internal or external to the wireless device 1000. The processing circuitry 1010 is configured to perform processing described above (e.g., in FIGS. 3-9), such as by executing instructions stored in memory 1030. The processing circuitry 1010 in this regard may implement certain functional means, units, or modules.

FIG. 11 is a block diagram of an example of a wired device 1100 according to some embodiments. As shown, the wired device 1100 includes processing circuitry 1110 and communication circuitry 1120. The communication circuitry 1120 is configured to transmit and/or receive information to and/or from one or more other nodes, e.g., via any communication technology. The processing circuitry 1110 is configured to perform processing described above (e.g., in FIGS. 3-9), such as by executing instructions stored in memory 1130. The processing circuitry 1110 in this regard may implement certain functional means, units, or modules.

A computer program comprises instructions which, when executed on processing circuitry of a device (e.g., a wireless device, a wired device, etc.), cause the device to carry out any of the respective processing described above. A computer program in this regard may comprise one or more code modules configured to perform one or more steps of the processing described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by processing circuitry of a device (e.g., a wireless device, a wired device, etc.), cause the device to perform as described above.

Embodiments further include a computer program product comprising program code portions for performing the steps of any of the embodiments herein when the computer program product is executed by a computing device. This computer program product may be stored on a computer readable recording medium.

In some embodiments, the device may be a wireless device, e.g., a mobile phone, a user equipment or a wireless sensor in internet of thing (IoT). In other embodiments, the device may be a wired device, e.g., a computer or server in any kind of network system. In other embodiments, the device may implement a virtualized function or a network function which may co-exist with another network function, e.g., it may co-exist with a network function in 3GPP network system.

References in the specification to “one embodiment,” “an embodiment,” “an example embodiment,” etc., indicate that the embodiment described may include a particular feature or a particular combination of features (e.g., component(s), element(s), integer(s), structure(s), operation(s), and/or step(s)), but every embodiment may not necessarily include the particular feature or the particular combination of features. Such phrases are not necessarily referring to the same embodiment. Further, when a particular feature, or a particular combination of features, is described in connection with an embodiment, it is submitted that it is within the knowledge of one skilled in the art to implement such feature, or combination of features, in connection with other embodiments whether or not explicitly described.

As used herein, the singular forms “a,” “an,” and “the” should include the plural forms, unless the context indicates otherwise. It will be further understood that the terms “comprises,” “comprising,” “includes,” and/or “including” when used, specify the presence of the stated feature or features, but do not preclude the presence or addition of one or more other features.

Unless otherwise defined, all terms (including technical and scientific terms) used herein have the same meaning as commonly understood by one of ordinary skill in the art to which this invention belongs. It will be further understood that terms used should be interpreted as having a meaning that is consistent with their meaning in the context of this specification and the relevant art and will not be interpreted in an idealized or overly formal sense unless expressly so defined herein.

The above-described embodiments are examples only. Alterations, modifications and variations may be affected to the particular embodiments by those of skill in the art without departing from the scope of the description, which is defined solely by the appended claims.

1.-27. (canceled)

28. A method performed by a device using network time protocol (NTP), the method comprising:
obtaining an original NTP key;
obtaining a local encryption key for encrypting the original NTP key;
encrypting the original NTP key using the obtained local encryption key; and
saving the encrypted NTP key.

29. The method according to claim 28, wherein encrypting the original NTP key further comprises encrypting the original NTP key using a hardware module.

30. The method according to claim 28, wherein the obtained local encryption key comprises a private key of a hardware module.

31. The method according to claim 29, wherein the hardware module comprises a Hardware Security Module (HSM) or a Trusted Platform Module (TPM).

32. The method according to claim 28, wherein encrypting the original NTP key further comprises encrypting the original NTP key using a software.

33. The method according to claim 28, wherein saving the encrypted NTP key further comprises adding an indication indicating that the NTP key is an encrypted NTP key.

34. The method according to claim 28, wherein saving the encrypted NTP key further comprises indicating an encryption algorithm used for encrypting the original NTP key.

35. The method according to claim 28, wherein saving the encrypted NTP key further comprises saving the encrypted NTP key to a file system of the device.

36. A method performed by a device using network time protocol (NTP), the method comprising:
obtaining an NTP key; and
determining whether the NTP key is an encrypted NTP key.

37. The method according to claim 36, further comprising, responsive to the NTP key being an encrypted NTP key, decrypting the encrypted NTP key.

38. The method according to claim 36, further comprising, responsive to the NTP key being an encrypted NTP key, determining whether the encrypted NTP key is encrypted with a latest version of an encryption algorithm if the encryption algorithm has been updated.

39. The method according to claim 38, further comprising, responsive to the encrypted NTP key being not encrypted with the latest version of the encryption algorithm:
decrypting the encrypted NTP key with a current encryption algorithm to obtain an original NTP key;
encrypting the original NTP key with the latest version of the encryption algorithm; and
saving the encrypted NTP key.

40. The method according to claim 37, wherein decrypting the encrypted NTP key further comprises decrypting the encrypted NTP key using a hardware module.

41. The method according to claim 40, further comprising decrypting the encrypted NTP key using a private key of the hardware module.

42. The method according to claim 36, further comprising, responsive to the NTP key not being an encrypted NTP key:
obtaining a local encryption key for encrypting the original NTP key;
encrypting the original NTP key using the obtained local encryption key; and
saving the encrypted NTP key.

43. The method according to claim 39, wherein encrypting the original NTP key further comprises encrypting the original NTP key using a hardware module.

44. A device configured to use network time protocol (NTP), the device comprising processing circuitry and memory, the memory containing instructions executable by the processing circuitry whereby the device is configured to:
obtain an original NTP key;
obtain a local encryption key for encrypting the original NTP key;
encrypt the original NTP key using the obtained local encryption key; and
save the encrypted NTP key.

45. The device according to claim 44, wherein the memory further contains instructions executable by the processing circuitry whereby the device is configured to encrypt the original NTP key using a hardware module.

46. A device configured to use network time protocol (NTP), the device comprising processing circuitry and memory, the memory containing instructions executable by the processing circuitry whereby the device is configured to:
obtain an NTP key;
determine whether the NTP key is an encrypted NTP key.

47. The device according to claim 46, wherein the memory further contains instructions executable by the processing circuitry whereby the device is configured to, responsive to the NTP key being an encrypted NTP key, decrypt the encrypted NTP key.
